(19) United States
(12) Patent Application Publication
(10) Pub. No.: US 2022/0363180 A1
(43) Pub. Date: Nov. 17, 2022

(54) SYSTEM INCLUDING A RECEPTACLE IN A MOTOR VEHICLE

(71) Applicant: fischer automotive systems GmbH & Co. KG, Horb a.N. (DE)

(72) Inventor: Ulf-Lothar Bastian, Pfalzgrafenweiler (DE)

(21) Appl. No.: 17/735,213

(22) Filed: May 3, 2022

(30) Foreign Application Priority Data
May 12, 2021 (DE) 10 2021 112 441.7

(51) Int. Cl. B60N 3/10

(52) U.S. Cl. CPC B60N 3/103; B60R 2011/0061

(57) ABSTRACT

So as to releasably fasten, in an accident-proof manner, a receptacle, which is, for example, cup-shaped, in a depression of a center console of a motor vehicle, serving as a seat for the receptacle, the invention provides a coupling including two detent elements which face away from one another and are disposed opposite one another, and which are urged apart by a spring element, catch lugs of which, projecting outwardly, extend over an edge of a rectangular fastening opening in a bottom of the receptacle. By rotating the receptacle by 30° to 45°, opposing corners of the fastening opening find their way beneath the catch lugs so that the receptacle can be removed from the seat.

### CROSS-REFERENCE TO RELATED APPLICATION

This application claims priority under 35 USC § 119 to German Patent Application No. 10 2021 112 441.7, filed May 12, 2021, the entire disclosure of which is incorporated herein by reference.

### TECHNICAL FIELD OF THE INVENTION

The invention relates to a system for releasably fastening a receptacle in a motor vehicle.

### DISCUSSION OF THE RELATED ART

A fastening device for, for example, a beverage holder or an electronic device in a motor vehicle is disclosed by the French patent application FR 3 100 502 A1. The fastening device includes a bayonet catch, including a circular fastening opening that has two recesses, located opposite one another, in an edge of the fastening opening in a bottom of the fastening device, and corresponding detent hooks on an underside of a bottom of, for example, the beverage holder. For fastening, the beverage holder is moved axially with respect to a center axis of the fastening opening, so that the detent hooks pass through the recesses of the fastening opening. By way of rotating of the beverage holder, the detent hooks reach beneath the edge of the fastening opening, thereby fastening the beverage holder. The beverage holder is released again by a rotation, until the detent hooks are aligned with the recesses of the fastening opening, whereupon the beverage holder can be axially removed. By way of a pressure plate, a helical compression spring urges the detent hooks upwardly against an underside of the edge of the fastening opening, so that the beverage holder is held rattle-free and without clearance.

### SUMMARY OF THE INVENTION

It is the object of the invention to provide a system for releasably fastening a receptacle in a motor vehicle, which allows the receptacle to be fastened and released easily and quickly and which reliably holds the receptacle in the event of an accident.

The system according to the invention includes a seat for a receptacle, the receptacle, and a coupling that releasably connects the receptacle to the seat. The seat is, in particular, a depression, for example in a center console of a motor vehicle, which is adapted to an outer shape of the receptacle and into which the receptacle can be introduced and in which the receptacle can be releasably fastened by way of the coupling. The seat can, generally speaking, also be a placement area or another surface or, generally speaking, an element in the motor vehicle on or at which the receptacle can be releasably fastened to the coupling. The seat does not need to be a separate component, but may be an integral part of the center console of the motor vehicle, for example.

The receptacle is, for example, a compartment for small parts, an ashtray, a beverage holder (a so-called cup holder), a smart phone holder, or the like.

The coupling is a connecting device by way of which the receptacle can be releasably connected to the seat.

The receptacle includes a non-circular fastening opening, which can be interpreted as part of the coupling. Furthermore, the coupling includes a detent element, which cooperates with the fastening opening and which, when the receptacle 15 is fastened, extends over an edge of the fastening opening such that the receptacle is fastened to the seat. The receptacle is released by rotation about a center axis, which passes perpendicularly through a center of the fastening opening. For this purpose, a shape of the fastening opening is matched to the detent element of the coupling such that the detent element is disengaged from the fastening opening of the receptacle by the rotation of the receptacle about the center axis of the fastening opening. As a result, the coupling is released, and the receptacle can be removed from the seat.

The receptacle can be released by a simple rotation and, when fastened, is held reliably at the seat in the motor vehicle.

A shape of the edge of the fastening opening is preferably configured and matched to the detent element such that the edge of the fastening opening causes the detent element to become disengaged from the fastening opening when the receptacle is rotated about the center axis of the fastening opening, whereby the coupling is released, and the receptacle can be removed from the seat.

The edge of the fastening opening is preferably shaped so that the edge slides along the detent element when the receptacle is being rotated about the center axis of the fastening opening and, in the process, the edge urges the detent element in the direction of the center axis of the fastening opening. The detent element is thereby moved inwardly in the direction of the center axis of the fastening opening, wherein the detent element becomes disengaged from the fastening opening. For example, the edge of the fastening opening slides along a shaft of the detent element when the receptacle is being rotated about the center axis of the fastening opening and, in the process, moves the detent element so far inwardly, in the direction of the center axis of the fastening opening, that a detent hook, a detent head, or the like, of the detent element, which extends over the edge of the fastening opening in the fastened state, clears the edge of the fastening opening, whereby the fastening is released.

Many polygonal and/or rounded, but not circular shapes are possible for the fastening opening. For example, the fastening opening can be oval or egg-shaped. The fastening opening is preferably polygonal, for example square or rectangular. For example, in the fastened state, the detent element extends over a straight edge of a polygonal fastening opening. During the rotation for releasing the receptacle, a corner of the fastening opening becomes aligned with the detent element, so that the detent element clears the edge of the fastening opening, and the receptacle can be removed.

An embodiment of the invention provides two detent elements that face away from one another and can be moved in opposite directions away from, and toward, one another, radially with respect to the center axis of the fastening opening. Generally speaking, “radial with respect to the center axis” also encompasses a movement that runs offset, parallel to a radial line of the center axis of the fastening opening. In particular, the directions of movement of the detent elements extend through the center axis. From the position in which the two detent elements extend over the edge of the fastening opening, the two detent elements facing away from one another can be moved inwardly, which is to say, closer to the center axis of the fastening opening, until these no longer extend over the edge of the fastening opening. In the fastened state, the two detent elements facing away from one another extend over the edge of the fastening opening in opposing locations, which enables reliable fastening of the receptacle, even in the event of an accident.

According to a refinement, a preloaded spring element urges the two detent elements apart so that they extend over the edge of the fastening opening in the opposing locations. “Preloaded” shall be understood to mean that the spring element also urges the two detent elements away from one another when these extend over the edge of the fastening opening in the opposing locations. When the coupling is released by the rotation of the receptacle about the center axis of the fastening opening, the edge of the fastening opening, which slides along the detent elements when the receptacle is being rotated, urges the two detent elements inwardly in the direction of the center axis of the fastening opening, against the spring action provided by the spring element, so that the detent elements clear the edge of the fastening opening, and the receptacle can be removed.

According to a refinement of the above embodiment of the invention, spring seats are provided for the spring element on sides of the detent elements which face one another. The spring seats can be cylindrical cavities, for example, in which ends of a helical compression spring, serving as the spring element, are accommodated.

An embodiment of the invention provides for at least one detent element, in the fastened position, to extend over an edge section of a polygonal fastening opening. In particular, in the fastened position, multiple detent elements each extend over an edge section of the polygonal fastening opening. In the fastened position, in particular, exactly two detent elements in each case extend over an edge section, wherein the two edges over which the detent elements extend are situated opposite one another, with respect to the center axis. The edge section is, or the edge sections are, in particular, straight. For releasing, the receptacle is rotated so that a corner of the fastening opening reaches a detent element, or corners of the fastening opening reach the detent elements. During the rotation, the edge section slides along the detent element, or the edge sections slide along the detent elements, pushing the detent element or detent elements inwardly in the direction of the center axis of the fastening opening. Moreover, the corners of the fastening opening reach the detent elements, whereby the detent elements clear the edge of the fastening opening, and the receptacle can be removed.

An embodiment of the invention provides a regular polygon, in particular a square, a hexagon or an octagon, as the fastening opening. Generally speaking, this embodiment of the invention provides as the fastening opening a polygon that is symmetrical to a straight center line of the fastening opening, which radially intersects the center axis of the fastening opening. A fastening opening in the shape of a trapezoid is also possible, for example.

The receptacle is fastened, in particular, by causing the detent element to approach in the direction of the center axis of the fastening opening, so that an edge of the fastening opening bears on the detent element. The detent element preferably includes a beveled surface on which the edge of the fastening opening bears, whereby the edge of the fastening opening urges the detent element inwardly in the direction of the center axis of the fastening opening. The edge of the fastening opening can pass the detent element until the detent element moves outwardly again and extends over the edge of the fastening opening, whereby the coupling is closed, and the receptacle is fastened at the seat.

To release the coupling, in exemplary embodiments of the invention, a rotation of the receptacle about the center axis of the fastening opening of preferably no more than 90° is required. In particular, a rotation of the receptacle of approximately 45°±5° or a rotation of no more than 20° to 30° about the center axis of the fastening opening suffices.

The fastening opening is preferably covered, for example by a double bottom or a double-walled configuration of the receptacle in the region of the fastening opening.

Viewed in the direction of the center axis of the fastening opening, the detent element in one embodiment of the invention includes a corner that points outwardly, away from the center axis of the fastening opening, and that, in the fastened position, extends over the edge of the fastening opening. Viewed in the direction of the center axis of the fastening opening, the detent element can also have a rounded shape or the shape of an arrowhead. When a corner of the fastening opening, viewed in the direction of the center axis of the fastening opening, is rotated to align with the detent element, the detent element, viewed in the direction of the center axis of the fastening opening, is located within the edge of the fastening opening.

The features and feature combinations, embodiments and configurations of the invention mentioned above in the description, and the features and feature combinations mentioned hereafter in the description of the figures and/or shown in a figure, can be used not only in the respective indicated or illustrated combinations, but also in other essentially arbitrary combinations, or alone. Embodiments of the invention that do not include all the features of a dependent claim are possible. It is also possible to replace individual features of a claim with other disclosed features or feature combinations. Embodiments of the invention that do not include all the features of the exemplary embodiment, but an essentially arbitrary portion of the characterizing features of the exemplary embodiment, are possible.

### BRIEF DESCRIPTION OF THE DRAWINGS

The invention will be described hereafter in greater detail based on one exemplary embodiment shown in the drawings. In the drawings:

FIG. 1 shows a system according to the invention in a perspective sectional illustration;

FIG. 2 shows an axial section in a lower region of the system based on FIG. 1;

FIG. 3 shows a view into a receptacle of the system, axially from above;

FIG. 4 shows a view of the system based on FIGS. 1 and 2, axially from above, with the receptacle in a fastened position; and

FIG. 5 shows the view of the system according to FIG. 4, with the receptacle in a released position.

### DETAILED DESCRIPTION OF THE EMBODIMENT

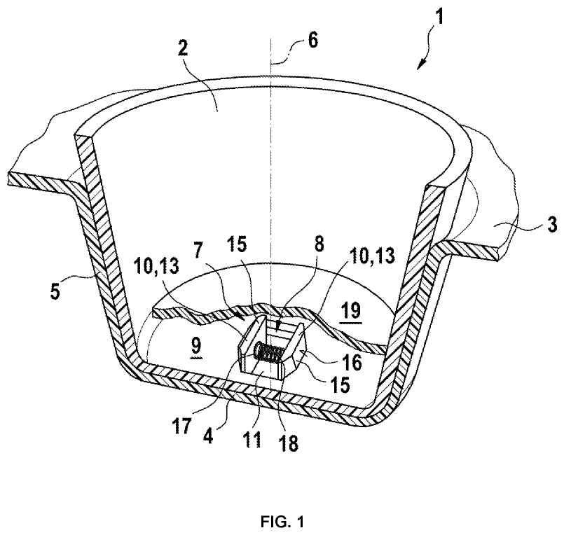

The system 1 according to the invention shown in FIG. 1 is provided for releasably fastening a receptacle 2 in an accident-proof manner in a motor vehicle, which is not shown. The receptacle 2 is cup-shaped in the exemplary embodiment. It can be a beverage holder, an ashtray or a storage compartment, for example. The shape and size of the receptacle 2 are not essential.

The system 1 is provided in a center console 3 of the motor vehicle, for example, FIG. 1 showing a sectional view of which in the region of the system 1. Other options for arranging the system 1 include, for example, door interior trim, other interior trim parts of a passenger compartment of the motor vehicle, or a dashboard (not shown).

The center console 3 includes a cylindrical or frustum-shaped depression including a bottom 4, serving as a seat 5 for the receptacle 2. The receptacle 2 has a shape that is adapted to the seat 5. In the exemplary embodiment, the receptacle 2 is likewise cylindrical or frustum-shaped, and in the exemplary embodiment is slightly higher, in an axial direction, than the seat 5 is deep.

For fastening the receptacle 2 in the seat 5, the system 1 according to the invention includes a coupling 7 that can be released by rotating the receptacle 2 about a center axis 6 of the receptacle 2 and the seat 5, wherein a “coupling” shall be understood to mean a device for connecting the receptacle 2 to the seat 5, which can be released, in the exemplary embodiment by rotating the receptacle 2 about the center axis 6, so as to be able to take or remove the receptacle 2 out of or from the seat 5.

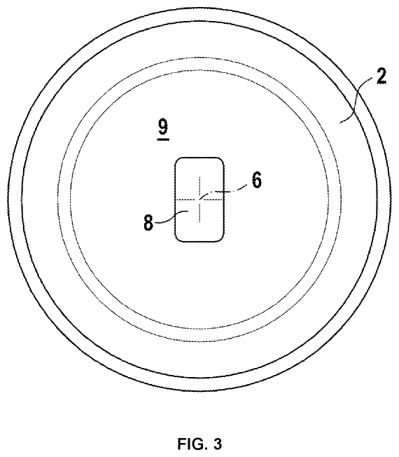

For releasable fastening in the seat 5, the receptacle 2 includes a fastening opening 8, which can be interpreted as an integral part of the coupling 7 and, in the exemplary embodiment, is located in a center of a bottom 9 of the receptacle 2. The center axis 6 extends through the fastening opening 8 perpendicularly in a centroid of area of the fastening opening 8. In the exemplary embodiment, the fastening opening 8 is rectangular having rounded “corners” (see FIG. 3). The invention does not preclude other, polygonal and/or round, but not circular shapes of the fastening opening 8.

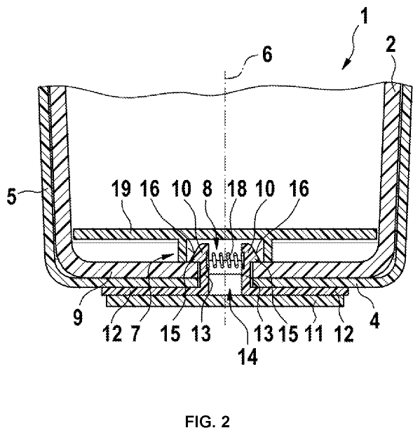

In the bottom 4, the seat 5 includes two detent elements 10, which are disposed opposite one another with respect to the center axis 6. The two detent elements 10 are guided in a C-profile rail, serving as a guide rail 11 that is arranged radially with respect to the center axis 6, so as to be radially displaceable with respect to the center axis 6 (FIG. 2). The guide rail 11 is disposed on an outer side or underside of the bottom 4 of the seat 5. The detent elements 10 are integral parts of the coupling 7.

Viewed from a side, the detent elements 10 are L-shaped and have two strip-shaped legs 12, 13, which in the exemplary embodiment are disposed perpendicularly to one another and of which a first leg 12 is guided in the guide rail 11 so as to be displaceable radially with respect to the center axis 6. The second two legs 13 are disposed parallel to one another and spaced apart from one another in two planes that are parallel to the center axis 6, and protrude into the seat 5 through a passage 14 in the center of the bottom 4 of the seat 5.

At the ends of the second legs 13 that are located furthest from the first legs 12, the detent elements 10 include catch lugs 15, which project outwardly, which is to say away from one another and from the center axis 6, from sides of the second legs 13 that face away from one another. Undersides of the catch lugs 15 which face the first legs 12 are located in a radial plane with respect to the center axis 6. Axially, which is to say viewed in the direction of the center axis 6 from above onto the detent elements 10, the catch lugs 15 are trapezoidal and project from outer sides of the second legs 13 of the detent elements 10 which face away from one another.

Top sides of the catch lugs 15 which face away from the first legs 12 of the detent elements 10 extend as beveled surfaces 16 at an angle with respect to a radial plane to the center axis 6, from the inside to the outside, obliquely downward in the direction of the first legs 12. This means that, at the second legs 13 of the detent elements 10, the top sides of the catch lugs 15 designed as beveled surfaces 16 are disposed at a larger distance from the first legs 12 than on the outside at a distance with respect to the second legs 13.

On the mutually facing inner sides, the second legs 13 of the detent elements 10 include cylindrical cavities, serving as spring seats 17 for ends of the helical compression spring, which is arranged radially with respect to the center axis 6 between the second legs 13 and which urges the two detent elements 10 away from one another and from the center axis 6, to the outside. The helical compression spring is generally referred to as a spring element 18 here. Spring elements other than the helical compression spring, for example a leaf spring that is bent in a U shape (not shown), which urge the two detent elements 10 to move apart, can also serve as the spring element 18.

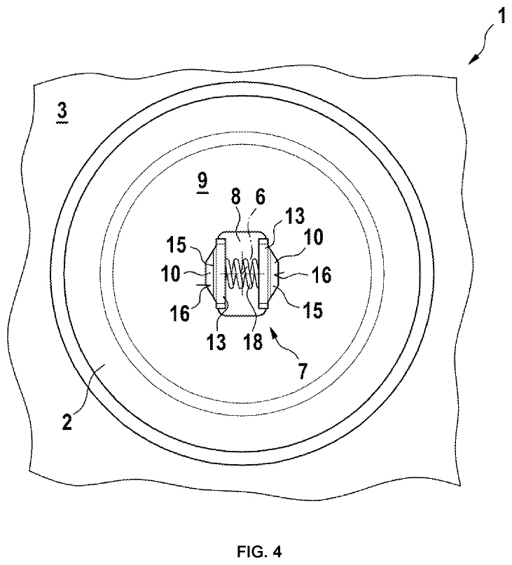

If the receptacle 2 of the system 1 according to the invention, as shown in FIG. 1, is disposed in the seat 5 and fastened in the seat 5 by way of the coupling 7, the second legs 13 of the detent elements 10 extend through the fastening opening 8 in the bottom 9 of the receptacle 2, and the outwardly projecting catch lugs 15 extend over an edge of the fastening opening 8 on an inner side facing away from the bottom 4 of the seat 5, or on a top side of the bottom 9 of the receptacle 2 (see FIGS. 2 and 4). The second legs 13 of the detent elements 10 are urged outwardly by the spring element 18 so as to rest against two opposing sides of the fastening opening 8 in the bottom 9 of the receptacle 2. The coupling 7 holds the receptacle 2 reliably in the seat 5, even in the event of an accident.

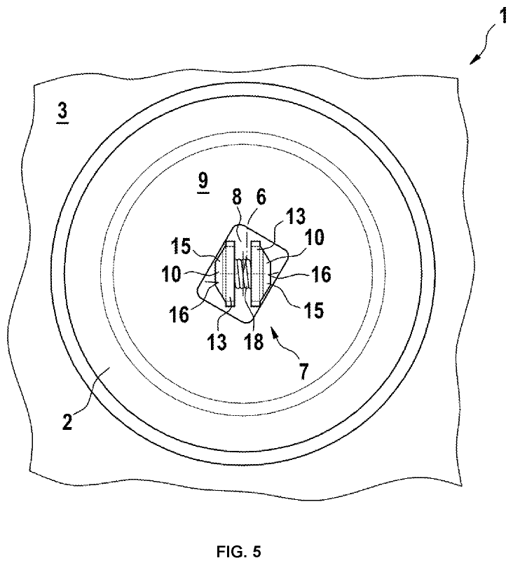

To release the coupling 7, the receptacle 2 is rotated manually by approximately 30° to 45° about the center axis 6 so that, as is apparent in FIG. 5, two opposing corners of the fastening opening 8 find their way beneath the catch lugs 15 of the detent elements 10. “Find their way beneath the catch lugs 15” shall be understood to mean that, viewed in the direction of the center axis 6, the catch lugs 15 become aligned with the two opposing corners of the fastening opening 8. When the receptacle 2 is rotated about the center axis 6, the straight sides of the edge of the rectangular fastening opening 8 slide along edges of the second legs 13 of the detent elements 10, urging the detent elements 10 inwardly in the direction of the center axis 6, against a spring force of the spring element 18. The detent elements 10 are urged inwardly so far that the catch lugs 15 thereof, viewed in the direction of the center axis 6, are situated entirely within the edge of the fastening opening 8. In this release position, the catch lugs 15 do not extend over the edge of the fastening opening 8. This is also in large part due to the shape of the fastening opening 8 and of the catch lugs 15 which, viewed in the direction of the center axis 6, are configured so as to not extend over the edge of the fastening opening 8 when the receptacle 2, as is shown in FIG. 5, is rotated approximately 30° to 45° about the center axis 6 into the release position. In the release position, the receptacle 2 can be axially removed from the seat 5 of the system 1 according to the invention. When the receptacle 2 has been removed from the seat 5, the spring element 18 urges the two detent elements 10 outwardly again.

For fastening the receptacle 2 in the seat 5, the receptacle 2 is introduced into the seat 5 in the direction of the center axis 6, wherein the edge of the fastening opening 8, in the bottom 9 of the receptacle 2, bears on the top sides of the catch lugs 15 of the two detent elements 10 configured as beveled surfaces 16. When pressure is applied to the receptacle 2 in the direction of the center axis 6 into the seat 5, the edge of the fastening opening 8 pushes the two detent elements 10, at the beveled surfaces 16 on the top sides of the catch lug 15 thereof, radially inwardly in the direction of the center axis 6, against the spring force of the spring element 18, until the edge of the fastening opening 8 is able to pass the catch lugs 15 on the outside in the direction of the bottom 4 of the seat 5. As soon as the catch lugs 15 are situated on the top side or inner side of the bottom 9 of the receptacle 2, the spring element 18 urges the detent elements 10 outwardly again, so that the catch lugs 15 extend over the edge of the fastening opening 8 in the bottom 9 of the receptacle 2, whereby the receptacle 2 is again releasably fastened in the seat 5 of the system 1 according to the invention.

On the inner side of the bottom 9, the receptacle 2 includes a circular disk-shaped cover 19, which is disposed at a distance with respect to the bottom 9 in the receptacle 2 that is at least as great as a height of the catch lugs 5 parallel to the center axis 6. The cover 19 covers the catch lugs 15 of the detent elements 10 of the coupling 7 and the fastening opening 8 in the bottom 9 of the receptacle 2.

### LIST OF REFERENCE NUMERALS

1 system
2 receptacle
3 center console
4 bottom of seat 5
5 seat
6 center axis
7 coupling
8 fastening opening
9 bottom of receptacle 2
10 detent element
11 guide rail
12 first leg
13 second leg
14 passage
15 catch lug
16 beveled surface
17 spring seat
18 spring element
19 cover

1. A system in a motor vehicle, comprising a seat, a receptacle and a coupling, which connects the receptacle releasably to the seat, wherein the receptacle includes a non-circular fastening opening and the coupling includes a detent element, which, in the fastened state, extends over an edge of the fastening opening of the receptacle such that the coupling releasably connects the receptacle to the seat, and that a shape of the fastening opening corresponds to a shape of the detent element so that the detent element is disengaged from the fastening opening of the receptacle by a rotation of the receptacle about a center axis of the fastening opening that extends perpendicularly through the fastening opening, whereby the fastening is released, and the receptacle can be removed from the seat.

2. The system according to claim 1, wherein the shape of an edge of the fastening opening disengages the detent element from the fastening opening when the receptacle is rotated about the center axis of the fastening opening.

3. The system according to claim 2, wherein the edge of the fastening opening is shaped so that the edge of the fastening opening (8) of the receptacle slides along the detent element when the receptacle is rotated about the center axis of the fastening opening, and the edge of the fastening opening urges the detent element in the direction of the center axis of the fastening opening such that the detent element is disengaged from the fastening opening.

4. The system according to claim 1, wherein the fastening opening is polygonal.

5. The system according to claim 1, wherein the coupling comprises two detent elements which face away from one another and can be moved in opposite directions away from and toward one another, radially with respect to the center axis of the fastening opening of the receptacle, and which, in the fastened state, extend over the edge of the fastening opening of the receptacle at opposing circumferential locations.

6. The system according to claim 5, wherein the coupling comprises a spring element, which is disposed in a preloaded state between the two detent elements and urges the two detent elements apart in the direction of the respective circumferential locations.

7. The system according to claim 6, wherein the detent elements include spring seats for the spring element on sides of the detent elements that face one another.

8. The system according to claim 4, wherein the fastening opening is shaped so that, for releasing the receptacle from the coupling, the receptacle must be rotated about the center axis of the fastening opening of the receptacle into a release position in such a way that the detent element points in the direction of a corner of the fastening opening of the receptacle, and that in the release position, viewed in the direction of the center axis of the fastening opening of the receptacle, the detent element does not extend over the edge of the fastening opening of the receptacle.

9. The system according to claim 4, wherein the fastening opening of the receptacle has the shape of a square, a hexagon or an octagon that is symmetrical to a center line of the fastening opening which radially intersects the center axis of the fastening opening, and the detent element, viewed in the direction of the center axis of the fastening opening of the receptacle, has the shape of a trapezoid.

10. The system according to claim 1, wherein the detent element includes a beveled surface, on which an edge of the fastening opening of the receptacle urges the detent element in the direction of the center axis of the fastening opening of the receptacle when, for the purpose of fastening, the receptacle is placed onto the detent element in the direction of the center axis of the fastening opening.

11. The system according to claim 1, wherein the shape of the edge of the fastening opening and the detent element are matched so that, in order to be released from the coupling, the receptacle can be rotated by no more than 90° about the center axis of the fastening opening of the receptacle.

12. The system according to claim 1, wherein the shape of the edge of the fastening opening and the detent element are matched so that, in order to be released from the coupling, the receptacle can be rotated by no more than 45° about the center axis of the fastening opening of the receptacle.

13. The system according to claim 1, wherein the shape of the edge of the fastening opening and the detent element are matched so that, in order to be released from the coupling, the receptacle can be rotated by no more than 20° to 30° about the center axis of the fastening opening of the receptacle.

14. The system according to claim 1, wherein the receptacle is an ashtray, a cup holder or a storage compartment and/or the fastening opening is covered.

15. The system according to claim 1, wherein the detent element, viewed in the direction of the center axis of the fastening opening, includes a corner that points outwardly away from the center axis and that, in the fastened position, extends over the edge of the fastening opening.
